(19) United States
(12) Patent Application Publication
(10) Pub. No.: US 2026/0319398 A1
(43) Pub. Date: Oct. 15, 2026

(54) IMAGE FORMING APPARATUS

(71) Applicant: KYOCERA Document Solutions Inc., Osaka (JP)

(72) Inventor: Yasushi IMANISHI, Osaka (JP)

(73) Assignee: KYOCERA Document Solutions Inc., Osaka (JP)

(21) Appl. No.: 19/638,925

(22) Filed: Apr. 3, 2026

(30) Foreign Application Priority Data
Apr. 11, 2025 (JP) 2025-065440

(51) Int. Cl. G03G 15/08

(52) U.S. Cl. CPC G03G 15/0813; G03G 15/0863; G03G 15/0891; G03G 15/0896; G03G 2215/085

(57) ABSTRACT

An image forming apparatus includes an image carrying member, a developing device, and a control portion. The developing device has a developing container storing developer, a stirring conveying member stirring and conveying the developer in the developing container, and a developer carrying member carrying the developer. When performing forced toner ejection operation to forcibly eject toner on the developer carrying member onto the image carrying member, the control portion performs either a standard mode with a toner ejection amount in forced toner ejection operation calculated based on the average printing rate of a predetermined number of sheets before forced toner ejection operation or an increased ejection amount mode with a toner ejection amount increased from the standard mode based on at least one of the development drive distance, i.e. the cumulative movement distance of the outer circumferential surface of the developer carrying member, and developer temperature in the developing container.

### INCORPORATION BY REFERENCE

This application is based on and claims the benefit of priority from Japanese Patent Application No. 2025-065440 filed on Apr. 11, 2025, the contents of which are hereby incorporated by reference.

### BACKGROUND

The present disclosure relates to an image forming apparatus such as a copier, a printer, a facsimile, or a multifunction peripheral incorporating the functions of all those that is provided with an image carrying member. More particularly, the present disclosure relates to an image forming apparatus that forcibly ejects toner from a developing device to the image carrying member.

In a conventional image forming apparatus that employs an electrophotographic process, when image formation is performed repeatedly, in particular if the printing rate of an image (i.e., the ratio of the printed area to the entire area where an image can be formed) is low, only a small amount of toner is ejected from a developing roller to a photosensitive drum (image carrying member) for use in development. Thus, toner particles in a developing device are not frequently replaced, and the toner becomes excessively charged electrostatically, leading to low image density and image fogging.

In such a case, it is possible to alleviate the problem by printing a pattern with a high printing rate, such as a solid image, to eject a large amount of toner from the developing roller to the photosensitive drum and thereby consume toner. However, if the apparatus is left without printing a solid pattern for a long time, while toner is barely consumed, toner particles may irrecoverably adhere to the surface of the developing roller due to humidity or the like.

### SUMMARY

According to one aspect of the present disclosure, an image forming apparatus includes an image forming portion that includes an image carrying member and a developing device, and a control portion that controls the image forming portion. On the surface of the image carrying member, an electrostatic latent image is formed. The developing device has a developing container that stores developer containing carrier and toner, a stirring conveying member that stirs and conveys the developer in the developing container, and a developer carrying member that is rotatably supported in the developing container and that carries the developer. The developing device develops the electrostatic latent image into a toner image by attaching the toner to the image carrying member. The image forming apparatus can perform forced toner ejection operation in which the toner on the developer carrying member is forcibly ejected onto the image carrying member. When performing the forced toner ejection operation, the control portion selectively performs either a standard mode in which the toner ejection amount in the forced toner ejection operation is calculated based on the average printing rate of a predetermined number of sheets before the forced toner ejection operation, or an increased ejection amount mode in which the toner ejection amount is increased compared with in the standard mode based on at least one of the development drive distance which is the cumulative movement distance of the outer circumferential surface of the developer carrying member and the developer temperature in the developing container.

### BRIEF DESCRIPTION OF THE DRAWINGS

FIG. 1 is a sectional view showing the internal construction of an image forming apparatus according to an embodiment of the present disclosure.

FIG. 2 is a side sectional view of a developing device incorporated in the image forming apparatus.

FIG. 3 is a sectional plan view showing a stirring portion in the developing device.

FIG. 4 is a block diagram showing one example of the control paths in the image forming apparatus.

FIG. 5 is a graph showing the change of an additional ejection amount α based on development drive distance.

FIG. 6 is a graph showing the change of an additional ejection amount β based on developer temperature.

FIG. 7 is a flowchart showing a first control example of forced toner ejection operation for the developing devices in the image forming apparatus of the present disclosure.

FIG. 8 is a flowchart showing a second control example of the forced toner ejection operation for the developing devices in the image forming apparatus of the present disclosure.

### DETAILED DESCRIPTION

### 1. Overall Construction of an Image Forming Apparatus

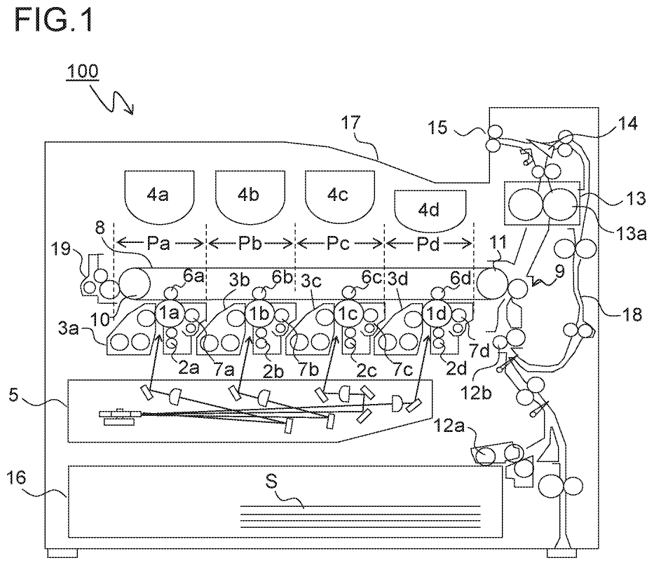

An embodiment of the present disclosure will be described below with reference to the accompanying drawings. FIG. 1 is a sectional view showing the internal construction of an image forming apparatus 100 according to the embodiment of the present disclosure. In the body of the image forming apparatus 100 (here, a color printer), four image forming portions Pa, Pb, Pc, and Pd are arranged in this order from upstream (left side in FIG. 1) in the conveying direction. These image forming portions Pa to Pd are provided for images of four different colors (cyan, magenta, yellow, and black), and sequentially form a cyan, a magenta, a yellow, and a black image respectively, each through the processes of electrostatic charging, exposure to light, image development, and image transfer.

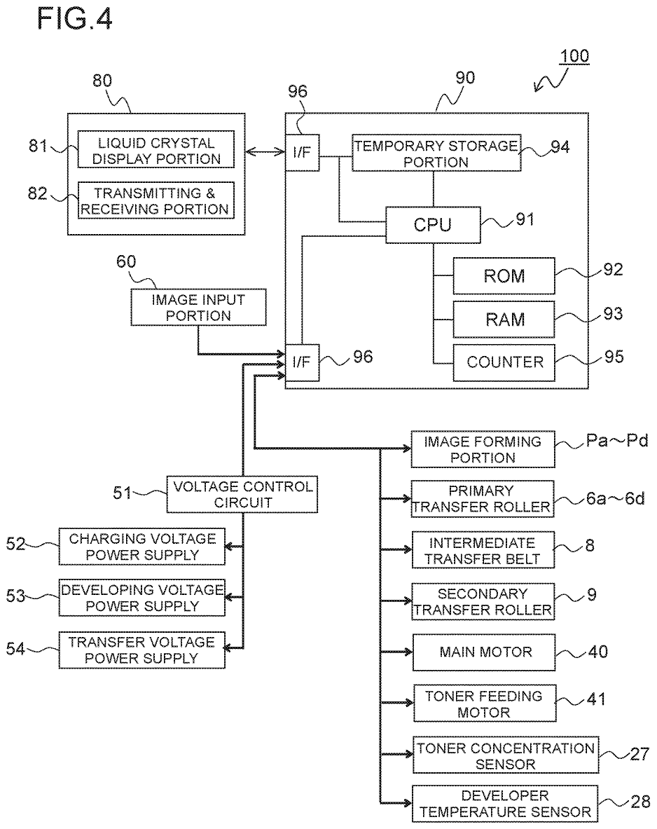

These image forming portions Pa to Pd include photosensitive drums (image carrying members) 1a, 1b, 1c, and 1d, respectively, that carry visible images (toner images) of the different colors. Furthermore, an intermediate transfer belt (intermediate transfer member) 8 that rotates counterclockwise in FIG. 1 by being driven by a belt driving motor (not illustrated) is provided adjacent to the image forming portions Pa to Pd. The toner images formed on these photosensitive drums 1a to 1d are primarily transferred sequentially to the intermediate transfer belt 8, which moves while in contact with the photosensitive drums 1a to 1d, and are superimposed on each other. After that, the toner images primarily transferred to the intermediate transfer belt 8 are secondarily transferred to a sheet S as one example of a recording medium by a secondary transfer roller 9. Moreover, the sheet S having the toner images secondarily transferred to it then has the toner images fixed to it in a fixing portion 13 and is then discharged out of the body of the image forming apparatus 100. While a main motor 40 (see FIG. 4) rotates the photosensitive drums 1a to 1d clockwise in FIG. 1, an image forming process is performed with respect to the photosensitive drums 1a to 1d.

A sheet S to which the toner images are to be secondarily transferred is stored in a sheet cassette 16 disposed in a lower part of the body of the image forming apparatus 100. The sheet S is conveyed to a nip portion between the secondary transfer roller 9 and a driving roller 11 for the intermediate transfer belt 8 via a sheet feed roller 12a and a pair of registration rollers 12b. Used as the intermediate transfer belt 8 is a sheet of a dielectric resin, typically a belt with no seams (seamless belt). Downstream of the secondary transfer roller 9, a blade-form belt cleaner 19 is disposed for removing the toner and the like remaining on the surface of the intermediate transfer belt 8.

Next, the image forming portions Pa to Pd will be described. Around and below the photosensitive drums 1a to 1d, which are rotatably arranged, there are provided charging devices 2a, 2b, 2c, and 2d that electrostatically charge the photosensitive drums 1a to 1d, an exposure device 5 that exposes the photosensitive drums 1a to 1d to light conveying image information, developing devices 3a, 3b, 3c, and 3d that form toner images on the photosensitive drums 1a to 1d, and cleaning devices 7a, 7b, 7c, and 7d that remove the developer(toner) and the like remaining on the photosensitive drums 1a to 1d.

When image data is fed from a host device such as a personal computer, first, the surfaces of the photosensitive drums 1a to 1d are electrostatically charged uniformly by the charging devices 2a to 2d. After that, the exposure device 5 shines light according to the image data onto the photosensitive drums 1a to 1d to form on them electrostatic latent images corresponding to the image data. The developing devices 3a to 3d are loaded with predetermined amounts of two-component developer containing cyan, magenta, yellow, and black toner. When the proportion of toner in the two-component developer in the developing devices 3a to 3d falls below a prescribed amount as toner images are formed as will be described later, toner is supplied from toner containers 4a to 4d to the developing devices 3a to 3d. The toner in the developer is supplied to the photosensitive drums 1a to 1d by the developing devices 3a to 3d and attaches to them electrostatically. This forms toner images corresponding to the electrostatic latent images formed by exposure to light from the exposure device 5.

Then, primary transfer rollers 6a to 6d produce electric fields with a predetermined voltage between themselves and the photosensitive drums 1a to 1d, and the cyan, magenta, yellow, and black toner images on the photosensitive drums 1a to 1d are primarily transferred to the intermediate transfer belt 8. These images are formed in a predetermined positional relationship previously determined. After that, in preparation for the subsequent formation of new electrostatic latent images, the toner and the like remaining on the surfaces of the photosensitive drums 1a to 1d after primary transfer are removed by the cleaning devices 7a to 7d.

The intermediate transfer belt 8 is stretched across a driven roller 10 at the upstream side and the driving roller 11 at the downstream side. When the intermediate transfer belt 8 starts to rotate counterclockwise as the driving roller 11 rotates, a sheet S is conveyed, with predetermined timing, from the pair of registration rollers 12b to the nip portion (secondary transfer nip portion) between the driving roller 11 and the secondary transfer roller 9 adjacent to it and the toner images on the intermediate transfer belt 8 are secondarily transferred to the sheet S. The sheet S having the toner images secondarily transferred to it is conveyed to the fixing portion 13.

The sheet S conveyed to the fixing portion 13 is heated and pressed by the pair of fixing rollers 13a such that the toner images are fixed to the surface of the sheet S to form a predetermined full-color image. The sheet S having the full-color image formed on it has its conveying direction switched by a branch portion 14 which branches into multiple directions and is then discharged to a discharge tray 17 by a pair of discharge rollers 15 as it is (or after being sent to a duplex conveying passage 18 to have images formed on both sides).

### 2. Configuration of the Developing Device

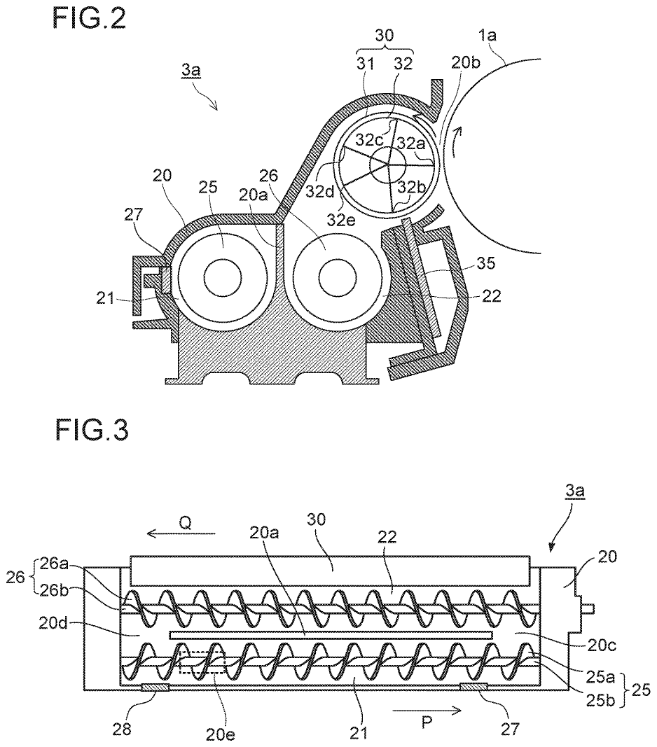

FIG. 2 is a side sectional view of the developing device 3a incorporated in the image forming apparatus 100. While the following description focuses on the developing device 3a disposed in the image forming portion Pa in FIG. 1, the developing devices 3b to 3d disposed in the image forming portions Pb to Pd have basically a similar configuration, and thus no overlapping description will be repeated.

As shown in FIG. 2, the developing device 3a includes a developing container 20 that stores two-component developer (hereinafter referred to simply as developer) containing magnetic carrier and toner, and the developing container 20 is divided into a stirring conveying chamber 21 and a supplying conveying chamber 22 by a partition wall 20a. In the stirring conveying chamber 21 and the supplying conveying chamber 22, a stirring conveying screw 25 and a supplying conveying screw 26, respectively, are rotatably provided that mix the toner supplied from the toner container 4a (see FIG. 1) with the magnetic carrier and that stir and that electrostatically charge them.

Then, by the stirring conveying screw 25 and the supplying conveying screw 26, the developer is conveyed along the axial direction (the direction orthogonal to the plane of FIG. 2) while being stirred, and circulates between the stirring conveying chamber 21 and the supplying conveying chamber 22 via an upstream communication portion 20c and a downstream communication portion 20d (for both see FIG. 3) formed in opposite end parts of the partition wall 20a. That is, the stirring conveying chamber 21, the supplying conveying chamber 22, and the upstream and downstream communication portions 20c and 20d constitute a circulation passage for developer in the developing container 20

The developing container 20 extends diagonally to the upper right in FIG. 2, and in the developing container 20, diagonally to the upper right of the supplying conveying screw 26, a developing roller 30 is disposed. Part of the outer circumferential surface of the developing roller 30 is exposed through an opening 20b in the developing container 20 and faces the photosensitive drum 1a. The developing roller 30 rotates counterclockwise in FIG. 2. The stirring conveying screw 25, the supplying conveying screw 26, and the developing roller 30 are rotated at a predetermined rotational speed with a driving force from the main motor 40 (see FIG. 4).

The developing roller 30 is configured with a cylindrical developing sleeve 31 that rotates counterclockwise in FIG. 2, and a magnet 32 fixed in the developing sleeve 31. The magnet 32 has five magnetic poles 32a to 32e, namely a main pole 32a, a regulating pole 32b, a conveying pole 32c, a releasing pole 32d, and an attracting pole 32e, which are fixed to a metallic shaft. When a driving force is fed to the developing device 3a, the developing sleeve 31 rotates while the magnet 32 remains stationary. While a developing sleeve 31 with a knurled surface is used here, it is also possible to use a sleeve with a large number of depressions (dimples) formed in its surface, one with a blasted surface, one subjected to knurling, depression formation, and in addition blasting, or one subjected to plating.

Furthermore, a regulating blade 35 is attached to the developing container 20 along the longitudinal direction of the developing roller 30 (the direction orthogonal to the plane of FIG. 2). A small space (gap) is formed between the tip end of the regulating blade 35 and the outer circumferential surface of the developing roller 30.

A developing voltage power supply 53 (see FIG. 4) is connected to the developing roller 30. The developing voltage power supply 53 applies, to the developing roller 30, a developing voltage having a DC voltage Vdc and an AC voltage Vac superimposed on each other. With the developing voltage and the magnetic force of the magnet 32 in the developing roller 30, developer is attached to the surface of the developing roller 30 to form a magnetic brush.

In the stirring conveying chamber 21, a toner concentration sensor 27 and a developer temperature sensor 28 are disposed to face the stirring conveying screw 25. The toner concentration sensor 27 detects the magnetic permeability of the developer in the developing container 20, and senses the toner concentration in the developer (the mix ratio of toner to carrier in the developer; T/C). A control portion 90 sends a control signal to a toner feeding motor 41(for both see FIG. 4) and, based on the toner concentration sensed by the toner concentration sensor 27, feeds toner from the toner container 4a (see FIG. 1) into the developing container 20 via a toner feeding port 20e (see FIG. 3) so as to keep the toner concentration of the developer in the developing container 20 at a reference toner concentration. The developer temperature sensor 28 measures the temperature of the developer in the developing container 20 (hereinafter referred to as the developer temperature).

Next, the configuration of a stirring portion in the developing device 3a will be described in detail. FIG. 3 is a sectional plan view showing the stirring portion in the developing device 3a. As described above, the developing container 20 includes the stirring conveying chamber 21, the supplying conveying chamber 22, the partition wall 20a, the upstream communication portion 20c, the downstream communication portion 20d, and the toner feeding port 20e. In the stirring conveying chamber 21, the left in FIG. 3 is upstream and the right in FIG. 3 is downstream. On the other hand, in the supplying conveying chamber 22, right in FIG. 3 is upstream and the left in FIG. 3 is downstream. Thus, the communication portions are referred to as the upstream and downstream ones with respect to the supplying conveying chamber 22.

The partition wall 20a extends along the longitudinal direction of the developing container 20 and divides the stirring conveying chamber 21 and the supplying conveying chamber 22 so that they are arranged side by side. A right end part of the partition wall 20a along its longitudinal direction forms the upstream communication portion 20c together with an inner wall portion of the developing container 20. A left end part of the partition wall 20a along its longitudinal direction forms the downstream communication portion 20d together with an inner wall portion of the developing container 20.

The toner feeding port 20e is an opening for feeding fresh toner stored in the toner container 4a (see FIG. 1) disposed above the developing container 20 into the developing container 20, and is disposed upstream (left in FIG. 3) along the developer conveying direction in the stirring conveying chamber 21.

The stirring conveying screw 25 has a rotation shaft 25b and a first helical blade 25a that is provided integrally on the rotation shaft 25b and that is formed in a spiral shape with a constant pitch along the axial direction of the rotation shaft 25b. The first helical blade 25a extends to opposite end parts of the stirring conveying chamber 21 along its longitudinal direction, up to positions facing the upstream and downstream communication portions 20c and 20d. The rotation shaft 25b is rotatably pivoted on opposite end parts of the developing container 20 along the longitudinal direction. The stirring conveying screw 25 conveys, while stirring, the developer in the stirring conveying chamber 21 in one direction (the direction of arrow P).

The supplying conveying screw 26 has a rotation shaft 26b and a second helical blade 26a that is provided integrally on the rotation shaft 26b and that is formed in a spiral shape, with its blade facing in the opposite direction to the first helical blade 25a, with the same pitch as the first helical blade 25a along the axial direction of the rotation shaft 26b. Furthermore, the second helical blade 26a has a length equal to or more than that of the developing roller 30 along its axial direction and extends up to positions facing the upstream and downstream communication portions 20c and 20d. The rotation shaft 26b is disposed parallel to the rotation shaft 25b and is rotatably pivoted on opposite end parts of the developing container 20 along its longitudinal direction. The supplying conveying screw 26 conveys, while stirring, the developer in the supplying conveying chamber 22 in the opposite direction (the direction of arrow Q) to the stirring conveying screw 25.

The toner fed through the toner feeding port 20e is stirred and mixed with the developer in the stirring conveying chamber 21 by the stirring conveying screw 25, and is electrostatically charged by friction with the carrier. When the developer is conveyed up to the downstream end of the stirring conveying chamber 21, it is delivered to the supplying conveying screw 26 via the upstream communication portion 20c. The developer is supplied to the developing roller 30 by the supplying conveying screw 26.

The developer supplied to the developing roller 30 is carried on the surface of the developing sleeve 31 under the magnetic field of the attracting pole 32e, and moves to a position facing the regulating pole 32b as the developing sleeve 31 rotates. Between the regulating pole 32b of the magnet 32 and the regulating blade 35, a magnetic field in an attracting direction is produced and this forms a magnetic brush made of chains of developer particles between the regulating blade 35 and the developing sleeve 31. The magnetic brush is regulated to have a desired height while passing across the regulating blade 35. Then, when the developing sleeve 31 rotates until the magnetic brush moves to a region (developing region) facing the photosensitive drum 1a, a magnetic field is produced by the main pole 32a, and thus the magnetic brush makes contact with the surface of the photosensitive drum 1a to develop an electrostatic latent image.

As the developing sleeve 31 rotates further counterclockwise, the conveying pole 32c produces a magnetic field in a direction along the outer circumferential surface of the developing sleeve 31, and together with the magnetic brush, the developer that has been left unused to form the toner image are collected onto the developing sleeve 31. Then, at the releasing pole 32d with the same polarity as the conveying pole 32c, the magnetic brush separates from the developing roller 30 to fall into the supplying conveying chamber 22.

The developer released from the developing roller 30 is stirred and conveyed with the supplying conveying screw 26, and is then supplied again to the developing roller 30 under the magnetic field of the attracting pole 32e to form a magnetic brush on the developing sleeve 31. The developer is then conveyed to the downstream end of the supplying conveying chamber 22 and is delivered again to the stirring conveying screw 25 via the downstream communication portion 20d.

In this way, the developer is stirred, while circulating from the stirring conveying chamber 21 through the upstream communication portion 20c, the supplying conveying chamber 22, and the downstream communication portion 20d, and the stirred developer is fed to the developing roller 30. When toner is consumed as images are developed, a toner feeding motor 41 feeds toner through the toner feeding port 20e into the stirring conveying chamber 21.

### 3. Control Paths in the Image Forming Apparatus

Next, a description will be given of control paths in the image forming apparatus 100. FIG. 4 is a block diagram showing one example of the control paths used in the image forming apparatus 100 of the embodiment. Since various kinds of control are performed on different parts of the image forming apparatus 100 in use, the control paths in the entire image forming apparatus 100 are complicated. For simplicity's sake, the description here will focus on those control paths that are necessary for the implementation of the present disclosure.

The control portion 90 includes at least a CPU (central processing unit) 91 as a central arithmetic processor, a ROM (read-only memory) 92 as a read-only storage, a RAM (random access memory) 93 as a readable-writable storage, a temporary storage portion 94 for temporarily storing image data and the like, a counter 95, and a plurality of (here, two) I/Fs (interfaces) 96 for transmitting control signals to different devices in the image forming apparatus 100 and receiving input signals from an operation portion 80. The control portion 90 can be disposed at any location in the main body of the image forming apparatus 100.

The ROM 92 stores data and the like that are not changed during the use of the image forming apparatus 100, such as control programs for the image forming apparatus 100 and numerical values required for control. The RAM 93 stores necessary data generated during the control of the image forming apparatus 100, data temporarily required for the control of the image forming apparatus 100, and the like. The counter 95 counts the number of printed sheets cumulatively.

The RAM 93 (or ROM 92) also stores an ejection distance setting table for setting toner ejection distances for different printing rate levels to set an optimal toner ejection amount (toner ejection distance) according to the printing rate of an image in forced toner ejection operation which will be described later.

The control portion 90 transmits control signals from the CPU 91 to different parts and devices in the image forming apparatus 100 via the I/Fs 96. On the other hand, from those different parts and devices, signals indicating their states and also input signals are transmitted to the CPU 91 via the I/Fs 96. The parts and devices controlled by the control portion 90 include, for example, the image forming portions Pa to Pd, the exposure device 5, the primary transfer rollers 6a to 6d, the secondary transfer roller 9, the toner concentration sensor 27, the developer temperature sensor 28, the main motor 40, the toner feeding motor 41, a voltage control circuit 51, and the operation portion 80.

The voltage control circuit 51 is connected to a charging voltage power supply 52, a developing voltage power supply 53, and a transfer voltage power supply 54, and operates these power supplies based on output signals from the control portion 90. Based on control signals from the voltage control circuit 51, predetermined voltages are applied respectively from the charging voltage power supply 52 to the charging devices 2a to 2d, from the developing voltage power supply 53 to the developing rollers 30 in the developing devices 3a to 3d, and from the transfer voltage power supply 54 to the primary transfer rollers 6a to 6d and to the secondary transfer roller 9.

An image input portion 60 is a receiving portion that receives image data transmitted from a personal computer or the like to the image forming apparatus 100. An image signal fed in from the image input portion 60 is converted into a digital signal and is then sent to the temporary storage portion 94.

The operation portion 80 is provided with a liquid crystal display portion 81 and a transmitting and receiving portion 82. The liquid crystal display portion 81 is configured to indicate the status of the image forming apparatus 100 as well as display the progress of image formation and the number of printed copies. Various settings for the image forming apparatus 100 are made via a printer driver on a personal computer. The transmitting and receiving portion 82 communicates with the outside via a telephone or internet network.

### 4. Adjustment of the Toner Ejection Amount in a Forced Toner Ejection Mode

As described above, since the developer in the supplying conveying chambers 22 of the developing devices 3a to 3d are consumed as images are developed, the toner concentration in the developer in the supplying conveying chamber 22 decreases downstream in the developer conveying direction (direction of arrow Q) by the supplying conveying screw 26. Furthermore, toner with a high electrostatic charge level (unlikely to be used for development) left unused for development is collected from the developing roller 30 into the supplying conveying chamber 22. Thus, when images with low printing rates are output continuously, the proportion of toner with a high electrostatic charge level increases downstream in the developer conveying direction (direction of arrow Q) in the supplying conveying chamber 22.

To cope with that, in the image forming apparatus 100 of the embodiment, when no formation of a print image based on image data fed to the image input portion 60 is performed (during a non-printing time), it is possible to perform forced toner ejection operation to forcibly eject the toner on the developing roller 30 onto the photosensitive drums 1a to 1d. Specifically, a solid image (uniform-density image) is formed on the surface of the photosensitive drums 1a to 1d to eject the toner in the developer carried by the developing roller 30 onto the photosensitive drums 1a to 1d. Performing forced toner ejection operation permits discharge of deteriorated toner with a high electrostatic charge level from the developing devices 3a to 3d and helps prevent a drop in image density.

The time to perform forced toner ejection operation is determined based on the average printing rate after the previous forced toner ejection operation. Specifically, every time the cumulative printing time after the previous forced toner ejection operation reaches a predetermined time (for example, two minutes), the average printing rate of output images per predetermined time is calculated. Then, if the calculated average printing rate is less than a threshold value (for example, 2%), forced toner ejection operation is performed.

The toner ejection amount in forced toner ejection operation is determined based on the average printing rate. Specifically, the toner ejection amount is increased as the average printing rate decreases to restore the average printing rate from less than the threshold value (for example, 2%) to equal to or more than the threshold value. The toner ejection amount can be controlled by changing the circumferential length of the solid image formed on the surface of the photosensitive drums 1a to 1d.

Here, as the developer deteriorates, charge injection occurs into the carrier and the photosensitive drums 1a to 1d. In particular, in a system using a developing voltage having an AC voltage superimposed on a DC voltage, a magnetic brush (development) current tends to flow, causing marked charge injection. If charge injection occurs, the potential in the image part changes in a direction approaching the DC voltage, and the charge polarity of the carrier also changes to the same polarity as that of the toner. As a result, carrier development occurs in which carrier is developed in the image part of the photosensitive drums 1a to 1d as toner is.

The carrier developed in the image part is then transferred to the intermediate transfer belt 8, which is made of resin, and intervenes between the photosensitive drums 1a to 1d and the intermediate transfer belt 8. This makes it difficult for the toner around the carrier to move from the photosensitive drums 1a to 1d to the intermediate transfer belt 8. As a result, white spots (white pattern) appear around the carrier. Deterioration of developer is more likely to progress the longer the cumulative movement distance of the outer circumferential surface of the developing roller 30 (hereinafter referred to as a development drive distance), and the higher the developer temperature in the developing devices 3a to 3d.

The normal toner ejection amount, which is set only to prevent a drop in image density, does not allow sufficient discharge of deteriorated toner, making it difficult to sufficiently suppress the appearance of white streaks as described above.

To cope with that, in the embodiment, forced toner ejection operation can be performed selectively in a standard mode, in which the toner ejection amount is changed according to the average printing rate of the output images, or in an increased ejection amount mode, in which the toner ejection amount is larger than in the standard mode. Each mode will be described below.

### Standard Mode

In the standard mode, the toner ejection amount is determined based on the average printing rate of the output images. For example, if the average printing rate per output image for the last two minutes before forced toner ejection operation is less than 2%, forced toner ejection operation is performed with a toner ejection amount that keeps an average printing rate of 2%. If the average printing rate for the last two minutes is 2% or more, forced toner ejection operation is not performed. When the average printing rate for the last two minutes is Pave [%] and the number of the output images is n [sheets], the toner ejection amount Mst in the standard mode is calculated by the following equation (1).

Mst=(2−Pave)×n (1)

### (Increased Ejection Amount Mode)

In this embodiment, the increased ejection amount mode includes a first increased mode, a second increased mode, and a third increased mode. In the first increased mode, when the development drive distance is equal to or more than a predetermined threshold value, the toner ejection amount is determined based on the average printing rate and the development drive distance. Specifically, the longer the development drive distance, the larger the toner ejection amount. The toner ejection amount M1 in the first increased mode is calculated by the following equation (2).

M1={(2−Pave)+α}×n (2)

α: Additional ejection amount based on development drive distance.

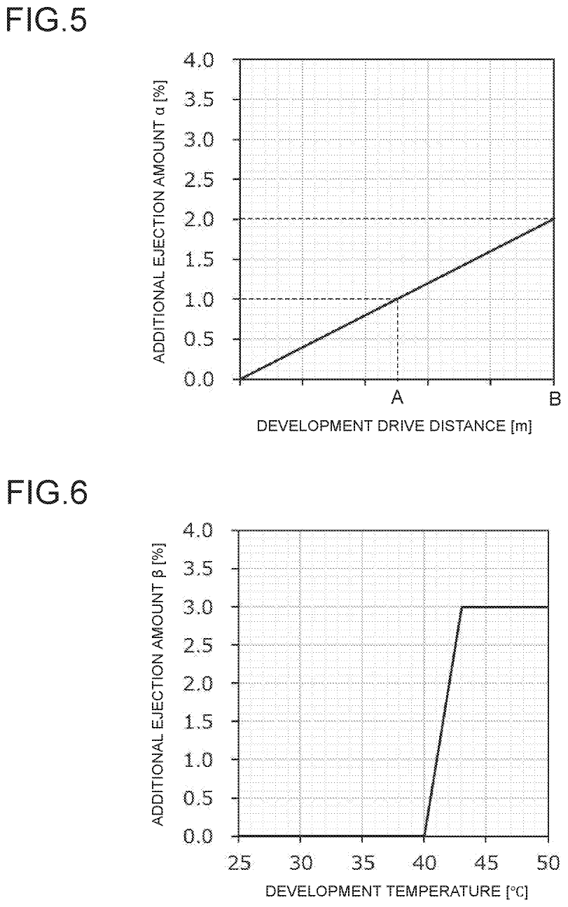

FIG. 5 is a graph showing the change of the additional ejection amount α based on the development drive distance. As shown in FIG. 5, if the additional ejection amount is 1.0% when the development drive distance is A, the additional ejection amount is 2.0% when the development drive distance is B (twice A). That is, as the development drive distance increases, the additional ejection amount α is increased linearly.

After forced toner ejection operation is completed, the development drive distance is reset. Thus, even if the additional ejection amount α is increased linearly as the development drive distance increases, the toner ejection amount does not increase indefinitely.

The development drive distance can be calculated based on the cumulative driving time of the developing devices 3a to 3d and the rotational speed (process speed) of the developing roller 30. When the image forming apparatus 100 has a plurality of printing modes with different process speeds, the additional ejection amount α is determined based on the sum of the development drive distances calculated from the printing times in different printing modes (cumulative driving time) and the process speed.

In the second increased mode, when the developer temperature is equal to or more than a predetermined threshold value (first threshold value), the toner ejection amount is determined based on the average printing rate and the developer temperature. Specifically, the higher the developer temperature, the larger the toner ejection amount. The first threshold value is set to, for example, a temperature 5 °C higher than the environmental temperature that guarantees the operation of the image forming apparatus 100. The toner ejection amount M2 in the second increased mode is calculated by the following equation (3).

M2={(2−Pave)+β}×n (3)

β: Additional ejection amount based on developer temperature.

FIG. 6 is a graph showing the change of the additional ejection amount β based on the developer temperature. As shown in FIG. 6, when the developer temperature is 40 °C or lower, the additional ejection amount is set to 0%, and when the developer temperature is between 40 °C (first threshold value) and 43 °C (second threshold value), the additional ejection amount β is increased linearly up to 3.0%. And, when the developer temperature is 43 °C or higher, the additional ejection amount β is kept at 3.0%. The developer temperature is measured with the developer temperature sensor 28 (see FIG. 4).

The additional ejection amount β based on the developer temperature shown in FIG. 6 does not change continuously like the additional ejection amount α based on the development drive distance shown in FIG. 5, but changes only between 40 °C and 43 °C. The reason is that the deterioration of developer hardly progresses when the developer temperature is below 40 °C, but progresses rapidly when the temperature is 40 °C or higher. Furthermore, in the region where the developer temperature is higher than 43 °C, increasing the toner ejection amount to more than 3.0% does not provide a sufficient effect, and rather increased toner consumption for other than printing causes an increase in running cost.

In the third increased mode, when the development drive distance and the developer temperature are equal to or more than predetermined threshold values, the toner ejection amount is determined based on the average printing rate, the development drive distance, and the developer temperature. The toner ejection amount M3 in the third increased mode is calculated by the following equation (4).

M3={(2−Pave)+α+β}×n (4)

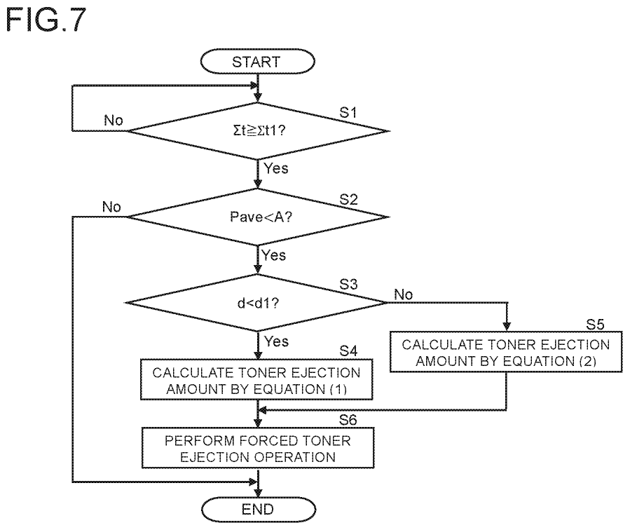

FIG. 7 is a flowchart showing a first control example of the forced toner ejection operation for the developing devices 3a to 3d in the image forming apparatus 100 of the present disclosure. With reference to FIGS. 1 to 6 as needed and along the steps in FIG. 7, a procedure for performing forced toner ejection operation for the developing devices 3a to 3d will be described.

First, the control portion 90 checks whether the cumulative printing time Σt after the previous forced toner ejection operation has reached a predetermined time Σt1 (for example, 2 minutes) (step S1). If the predetermined time Σt1 has not been reached (No in step S1), printing is continued.

If Σt≥Σt1 (Yes in step S1), the control portion 90 calculates the average printing rate Pave for the last predetermined time (for example, 2 minutes), and checks whether Pave is less than a threshold value A (step S2). To calculate the average printing rate Pave, first, the printing rate P for each image is calculated based on image data stored in the temporary storage portion 94. The calculated printing rate P is stored in the RAM 93. Then, the cumulative printing rate ΣP, which is the sum of the printing rate P for each image, is divided by the number of printed sheets to calculate the average printing rate Pave. If Pave <A (Yes in step S2), execution of the forced toner ejection operation is determined.

Next, the control portion 90 checks whether the development drive distance d is less than a threshold value d1 (step S3). If d<d1 (Yes in step S3), to perform forced toner ejection operation in the standard mode in which the toner ejection amount is determined based on the average printing rate of the output images, the toner ejection amount is calculated by the above-mentioned equation (1) (step S4).

If d≥d1 (No in step S3), to perform forced toner ejection operation in the first increased mode in which the toner ejection amount is determined based on the average printing rate and the development drive distance, the toner ejection amount is calculated by the above-mentioned equation (2) (step S5).

Then, the forced toner ejection operation is performed with the toner ejection amount determined in step S4 or step S5 (step S6). On the other hand, if Pave ≥A in step S2 (No in step S2), the forced toner ejection operation is not performed, and the procedure ends.

According to the first control example described above, until the development drive distance reaches the threshold value, the forced toner ejection operation is performed in the standard mode in which the toner ejection amount is determined based on the average printing rate of the output images, and when the development drive distance becomes equal to or more than the threshold value, the forced toner ejection operation is performed in the increased ejection amount mode (first increased mode) in which the toner ejection amount is determined based on the average printing rate and the development drive distance. In this way, even if the deterioration of the developer progresses as the development drive distance increases, it is possible to optimize the toner ejection amount and thereby prevent unnecessary toner ejection, and to prevent the appearance of white streaks.

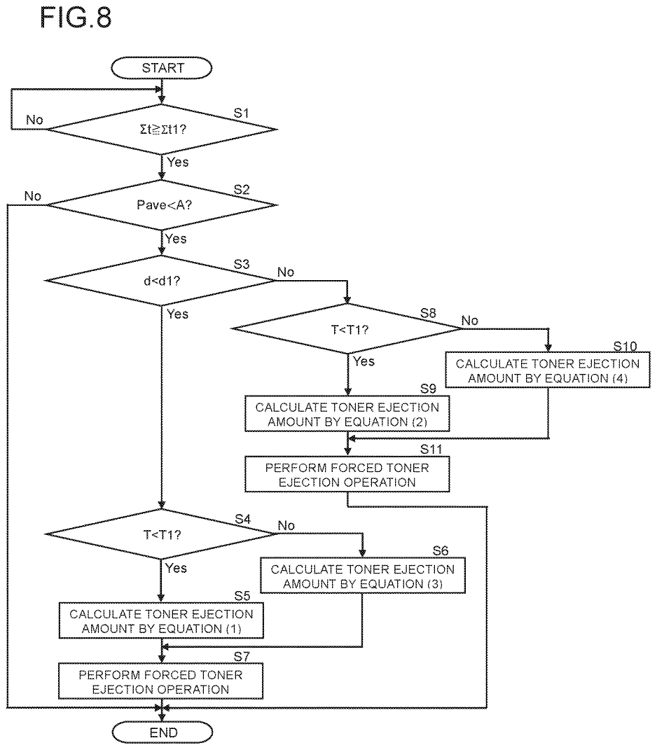

FIG. 8 is a flowchart showing a second control example of the forced toner ejection operation for the developing devices 3a to 3d in the image forming apparatus 100 of the present disclosure. With reference to FIGS. 1 to 6 as needed and along the steps in FIG. 8, a procedure for forced toner ejection operation for the developing devices 3a to 3d will be described in detail.

The check of whether the cumulative printing time Σt after the previous forced toner ejection operation has reached a predetermined time Σt1 (step S1), the calculation of the average printing rate Pave, and the check of whether Pave <A (step S2) are performed as in the first control example shown in FIG. 7.

If forced toner ejection operation is performed (Yes in step S2), the control portion 90 checks whether the development drive distance d is less than a threshold value d1 (step S3). If d<d1 (Yes in step S3), the control portion 90 checks whether the developer temperature T is less than a threshold value T1 (step S4).

If T<T1 (Yes in step S4), to perform forced toner ejection operation in the standard mode in which the toner ejection amount is determined based on the average printing rate of the output images, the toner ejection amount is calculated by the above-mentioned equation (1) (step S5). If T≥T1 (No in step S4), to perform forced toner ejection operation in the second increased mode in which the toner ejection amount is determined based on the average printing rate and the developer temperature, the toner ejection amount is calculated by the above-mentioned equation (3) (step S6). Then, the forced toner ejection operation is performed with the toner ejection amount determined in step S5 or step S6 (step S7).

On the other hand, if d≥d1 in step S3 (No in step S3), the control portion 90 checks whether the developer temperature T is less than the threshold value T1 (step S8). If T<T1 (Yes in step S8), to perform forced toner ejection operation in the first increased mode in which the toner ejection amount is determined based on the average printing rate and the development drive distance, the toner ejection amount is calculated by the above-mentioned equation (2) (step S9).

If T≥T1 (No in step S8), to perform forced toner ejection operation in the third increased mode in which the toner ejection amount is determined based on the average printing rate, the development drive distance, and the developer temperature, the toner ejection amount is calculated by the above-mentioned equation (4) (step S10).

Then, the forced toner ejection operation is performed with the toner ejection amount determined in step S9 or step S10 (step S11). On the other hand, if Pave≥A in step S2 (No in step S2), the forced toner ejection operation is not performed, and the procedure ends.

According to the second control example described above, until the development drive distance and the developer temperature reach the threshold values, the forced toner ejection operation is performed in the standard mode in which the toner ejection amount is determined based on the average printing rate of the output images, and when at least one of the development drive distance and the developer temperature becomes equal to or more than the threshold value, the forced toner ejection operation is performed in the increased ejection amount mode (first to third increased modes) in which the toner ejection amount is determined based on the average printing rate, the development drive distance, and the developer temperature. This makes it possible to more effectively optimize the toner ejection amount according to the degree of deterioration of the developer and thereby prevent unnecessary toner ejection, and to prevent the appearance of white streaks.

A plurality of increased ejection amount modes with different toner ejection amounts (different additional ejection amounts α and β) may be stored in the ROM 92 (or RAM 93), and one of the increased ejection amount modes may be selected based on input on the operation portion 80. This makes it possible to select an increased ejection amount mode that suits the environment and conditions of use by the user.

Furthermore, for example, a predetermined restriction (such as a password) may be placed on input operation on the operation portion 80 so that only a service person can select an increased ejection amount mode and the user cannot freely select one; it is thus possible to prevent a shortage of toner ejection amount and an increase in unnecessary toner ejection amount resulting from selection of an incorrect increased ejection amount mode.

The embodiment described above is not meant to limit the scope of the present disclosure, which thus allows for any modifications without departure from the spirit of what is disclosed herein. For example, while the above embodiment deals with an intermediate transfer type image forming apparatus 100 that secondarily transfers to a sheet S a toner image primarily transferred to an intermediate transfer belt 8, this is not meant as any limitation and the present disclosure is applicable equally to a direct transfer type image forming apparatus that directly transfers to a sheet a toner image formed on a photosensitive drum.

While the embodiment described above deals with, as an example of an image forming apparatus 100, a color printer as shown in FIG. 1, it can instead be any other image forming apparatus such as a monochrome printer, a monochrome or color copier, a digital multifunction peripheral, or a facsimile.

The present disclosure is applicable to an image forming apparatus that forcibly ejects toner from a developing device onto an image carrying member. According to the present disclosure, it is possible to provide an image forming apparatus that effectively helps prevent the appearance of image defects such as white streaks while optimizing the toner ejection amount in forced toner ejection operation.

What is claimed is:

1. An image forming apparatus comprising:
an image forming portion including:
an image carrying member on a surface of which an electrostatic latent image is formed; and
a developing device having:
a developing container that stores developer containing carrier and toner;
a stirring conveying member that stirs and conveys the developer in the developing container; and
a developer carrying member rotatably supported in the developing container, the developer carrying member carrying the developer,
the developing device developing the electrostatic latent image into a toner image by attaching the toner to the image carrying member, and
a control portion that controls the image forming portion;
the image forming apparatus being operable to perform forced toner ejection operation in which the toner on the developer carrying member is forcibly ejected onto the image carrying member, and
wherein
when the forced toner ejection operation is performed, the control portion selectively performs either
a standard mode in which a toner ejection amount in the forced toner ejection operation is calculated based on an average printing rate of a predetermined number of sheets before the forced toner ejection operation, or
an increased ejection amount mode in which the toner ejection amount is increased compared with in the standard mode based on at least one of
a development drive distance which is a cumulative movement distance of an outer circumferential surface of the developer carrying member and
a developer temperature in the developing container.

2. The image forming apparatus according to claim 1, wherein
the control portion is operable to calculate the development drive distance based on a cumulative driving time of the developing device and a rotational speed of the developer carrying member, and
the increased ejection amount mode includes a first increased mode in which the toner ejection amount is determined based on the average printing rate and the development drive distance.

3. The image forming apparatus according to claim 1, further comprising:
a developer temperature sensor that measures the developer temperature in the developing container,
wherein
the increased ejection amount mode includes a second increased mode in which the toner ejection amount is determined based on the average printing rate and the developer temperature.

4. The image forming apparatus according to claim 2, further comprising:
a developer temperature sensor that measures the developer temperature in the developing container,
wherein
the increased ejection amount mode includes a third increased mode in which the toner ejection amount is determined based on the average printing rate, the development drive distance, and the developer temperature.

5. The image forming apparatus according to claim 4, wherein
in the first or third increased mode, the control portion increases the toner ejection amount linearly as the development drive distance increases.

6. The image forming apparatus according to claim 2, wherein
the image forming apparatus has a plurality of printing modes that differ in the rotational speed of the developer carrying member, and
the control portion determines the toner ejection amount based on a sum of the development drive distance calculated from the printing time and the rotational speed of the developer carrying member in each of the plurality of printing modes.

7. The image forming apparatus according to claim 3, wherein
in the second increased mode, when the developer temperature becomes equal to or more than a first threshold value, the control portion increases the toner ejection amount linearly as the developer temperature rises and, when the developer temperature reaches a second threshold value higher than the first threshold value, the control portion stops increasing the toner ejection amount.

8. The image forming apparatus according to claim 7, wherein
the first threshold value is set to a temperature 5 °C higher than an environmental temperature that guarantees operation of the image forming apparatus.

9. The image forming apparatus according to claim 4, wherein
in the third increased mode, when the developer temperature becomes equal to or more than a first threshold value, the control portion increases the toner ejection amount linearly as the developer temperature rises, and when the developer temperature reaches a second threshold value higher than the first threshold value, the control portion stops increasing the toner ejection amount.

10. The image forming apparatus according to claim 9, wherein
the first threshold value is set to a temperature 5 °C higher than an environmental temperature that guarantees operation of the image forming apparatus.

11. The image forming apparatus according to claim 1, further comprising:
a storage portion that stores a plurality of the increased ejection amount modes with different toner ejection amounts; and
an input portion for selecting one of the plurality of increased ejection amount modes stored in the storage portion,
wherein
the control portion performs the forced toner ejection operation with the increased ejection amount mode selected on the input portion.

12. The image forming apparatus according to claim 11, wherein
the control portion permits the increased ejection amount mode to be changed only when input operation on the input portion satisfies a predetermined condition.
